(19) United States
(12) Patent Application Publication
(10) Pub. No.: US 2025/0285432 A1
(43) Pub. Date: Sep. 11, 2025

(54) IDENTIFICATION RESULT DETERMINATION

(71) Applicant: Tencent Technology (Shenzhen) Company Limited, Shenzhen (CN)

(72) Inventors: Jun WANG, Shenzhen (CN); Jinkun HOU, Shenzhen (CN); Runzeng GUO, Shenzhen (CN); Shaoming WANG, Shenzhen (CN)

(73) Assignee: Tencent Technology (Shenzhen) Company Limited, Shenzhen (CN)

(21) Appl. No.: 19/218,124

(22) Filed: May 23, 2025

Related U.S. Application Data
(63) Continuation of application No. PCT/CN2024/075007, filed on Jan. 31, 2024.

(30) Foreign Application Priority Data
Apr. 12, 2023 (CN) 202310415584.8

(51) Int. Cl. G06V 10/98; G06V 10/74; G06V 10/771; G06V 10/776; G06V 10/80; G06V 20/70; G06V 40/16; G06V 40/20; G06V 40/70

(52) U.S. Cl. CPC G06V 10/98; G06V 10/761; G06V 10/771; G06V 10/806; G06V 40/176; G06V 40/70; G06V 10/776; G06V 20/70; G06V 40/28

(57) ABSTRACT

In a method for determining a user account, a plurality of images of a to-be-identified target is obtained, including a plurality of types of images. Each type of the plurality of types of images is obtained using a different acquisition mode. For each type of image, a weighting factor is determined based on an image quality. For each candidate user account, an identification result is obtained based on the weighting factors and image matching degrees of the plurality of types of images. The image matching degree indicates a degree of feature matching between the to-be-identified target and the respective candidate user account based on the respective type of image. Based on the identification results, the user account that matches the to-be-identified target is determined from the plurality of candidate user accounts. Apparatus and non-transitory computer-readable storage medium counterpart embodiments are also contemplated.

### RELATED APPLICATIONS

The present application is a continuation of International Application No. PCT/CN2024/075007, filed on Jan. 31, 2024, which claims priority to Chinese Patent Application 202310415584.8, filed on Apr. 12, 2023. The entire disclosures of the prior applications are hereby incorporated by reference.

### FIELD OF THE TECHNOLOGY

This application relates to the field of human-computer interaction technologies, including an identification result determination method.

### BACKGROUND OF THE DISCLOSURE

With the development of artificial intelligence technologies, a target identification authentication technology is continuously updated. Application scenarios of the target identification authentication technology are extended to scenarios such as opening a gate by hand swiping authentication, paying by hand swiping authentication, punching the clock by hand swiping authentication, paying by face swiping authentication, and punching the clock by face swiping authentication. The target identification authentication technology brings more conveniences to life.

In related art, a related device acquires both a color image and an infrared image for a to-be-identified target, and identifies, based on the color image and the infrared image, a user account corresponding to the palm.

However, since a photographing environment is complex in an offline use process of the related device, image quality of images obtained using different acquisition modes are different, and accuracy of matching and identification that are performed according to different types of images is affected.

### SUMMARY

Aspects of this disclosure include an identification result determination method, an apparatus, and a non-transitory computer-readable storage medium, which can improve target identification accuracy. Examples of technical solutions of this disclosure may be implemented as follows:

An aspect of this disclosure provides a method for determining a user account. A plurality of images of a to-be-identified target is obtained. The plurality of images includes a plurality of types of images. Each type of the plurality of types of images is obtained using a different acquisition mode. For each type of image in the plurality of types of images, a weighting factor of the respective type of image is determined based on an image quality of the respective type of image. For each candidate user account of a plurality of candidate user accounts, an identification result associated with the respective candidate user account is obtained based on the weighting factors of the plurality of types of images and image matching degrees of the plurality of types of images. The image matching degree of each of the plurality of types of images indicates a degree of feature matching between the to-be-identified target and the respective candidate user account based on the respective type of image. Based on the identification results of the plurality of candidate user accounts, the user account that matches the to-be-identified target is determined from the plurality of candidate user accounts.

An aspect of this disclosure provides an apparatus. The apparatus includes processing circuitry configured to obtain a plurality of images of a to-be-identified target. The plurality of images includes a plurality of types of images. Each type of the plurality of types of images is obtained using a different acquisition mode. The processing circuitry is configured to determine, for each type of image in the plurality of types of images, a weighting factor of the respective type of image based on an image quality of the respective type of image. For each candidate user account of a plurality of candidate user accounts, the processing circuitry is configured to obtain an identification result associated with the respective candidate user account based on the weighting factors of the plurality of types of images and image matching degrees of the plurality of types of images. The image matching degree of each of the plurality of types of images indicates a degree of feature matching between the to-be-identified target and the respective candidate user account based on the respective type of image. The processing circuitry is configured to determine, based on the identification results of the plurality of candidate user accounts, the user account that matches the to-be-identified target from the plurality of candidate user accounts.

An aspect of this disclosure provides a non-transitory computer-readable storage medium storing instructions which when executed by a processor cause the processor to perform any of the methods of this disclosure.

Technical solutions provided in this disclosure can include the following beneficial effects:

After the plurality of different types of images corresponding to the to-be-identified target are obtained, the weighting factors of the types of images are determined according to the imaging qualities respectively corresponding to the plurality of different types of images, and then the user account matched with the to-be-identified target is determined from the plurality of candidate user accounts based on the weighting factors of the types of images and with reference to the types of images, so that in the aspects of this disclosure, the user account matched with the to-be-identified target can be determined according to the imaging qualities of the images. Proper and accurate allocation of the weighting factors of the types of images are conductive to improving accuracy of an identification result, thereby improving target identification accuracy. Especially in a scenario with complex light, by allocating the weighting factors of the types of images properly and accurately, an image with a good imaging quality has high impact on an identification result, and an image with a poor imaging quality has low impact on an identification result, thereby improving the target identification accuracy.

### BRIEF DESCRIPTION OF THE DRAWINGS

FIG. 1 is a schematic diagram of a solution implementation environment according to an aspect of this disclosure.

FIG. 2 is a schematic diagram of a quality evaluation model according to an aspect of this disclosure.

FIG. 3 is a flowchart of an identification result determination method according to an aspect of this disclosure.

FIG. 4 is a flowchart of an identification result determination method according to another aspect of this disclosure.

FIG. 5 is a schematic diagram of a method for obtaining a bounding box according to an aspect of this disclosure.

FIG. 6 is a schematic diagram of a target detection method according to an aspect of this disclosure.

FIG. 7 is a schematic diagram of a target detection network according to an aspect of this disclosure.

FIG. 8 is a schematic diagram of key points according to an aspect of this disclosure.

FIG. 9 is a schematic diagram of a key point detection network according to an aspect of this disclosure.

FIG. 10 is a schematic diagram of a method for obtaining a region-of-interest image according to an aspect of this disclosure.

FIG. 11 is a schematic diagram of a region-of-interest image according to an aspect of this disclosure.

FIG. 12 is a schematic diagram of a quality evaluation network according to an aspect of this disclosure.

FIG. 13 is a flowchart of a method for obtaining a weighting factor according to an aspect of this disclosure.

FIG. 14 is a schematic diagram of a palm swiping authentication method according to an aspect of this disclosure.

FIG. 15 is a schematic diagram of a method for obtaining an identification score according to an aspect of this disclosure.

FIG. 16 is a block diagram of an identification result determination apparatus according to an aspect of this disclosure.

FIG. 17 is a block diagram of an identification result determination apparatus according to another aspect of this disclosure.

FIG. 18 is a block diagram of a computer device according to an aspect of this disclosure.

### DETAILED DESCRIPTION

To make the objectives, technical solutions, and advantages of this disclosure clearer, the following further describes examples of implementations of this disclosure in further detail with reference to the accompanying drawings. Further, the descriptions of the terms are provided as examples only and are not intended to limit the scope of the disclosure.

Artificial intelligence (AI) is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

The CV is a science that studies how to use a machine to “see”, and furthermore, that uses a camera and a computer to replace human eyes to perform machine vision such as identification, tracking, and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The computer vision technologies include technologies such as image processing, image identification, image semantic understanding, image retrieval, video processing, optical character identification (OCR), video semantic understanding, video content/behavioral identification, three-dimensional object reconstruction, a three-dimensional (3D) technology, virtual reality, augmented reality, and map construction, and further include common feature identification technologies such as face identification and fingerprint identification.

Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning include technologies such as an artificial neural network, a belief network, reinforcement learning, transfer learning, inductive learning, and learning from demonstrations.

The technical solutions provided in the aspects of this disclosure relate to a computer vision technology and a machine learning technology of artificial intelligence. An image is processed by using the computer vision technology, to obtain a quality score of the image and a target feature of a to-be-identified target in the image, and then the to-be-identified target is identified according to the quality score of the image and the target feature of the to-be-identified target, to obtain an identification result. Meanwhile, in the aspects of this disclosure, a quality evaluation model is further trained according to the quality score of the image by using the machine learning technology, to obtain a quality evaluation model that can accurately obtain the quality score of the image.

The technical solutions provided in the aspects of this disclosure are applicable to any scenario in which target identification is needed, such as a palm swiping authentication scenario, a face swiping authentication scenario, a target identification scenario, a security check scenario, or a payment scenario. The technical solutions provided in the aspects of this disclosure can improve target identification accuracy. The to-be-identified target is not limited in the aspects of this disclosure, and may be any object, such as a person or a part of a person.

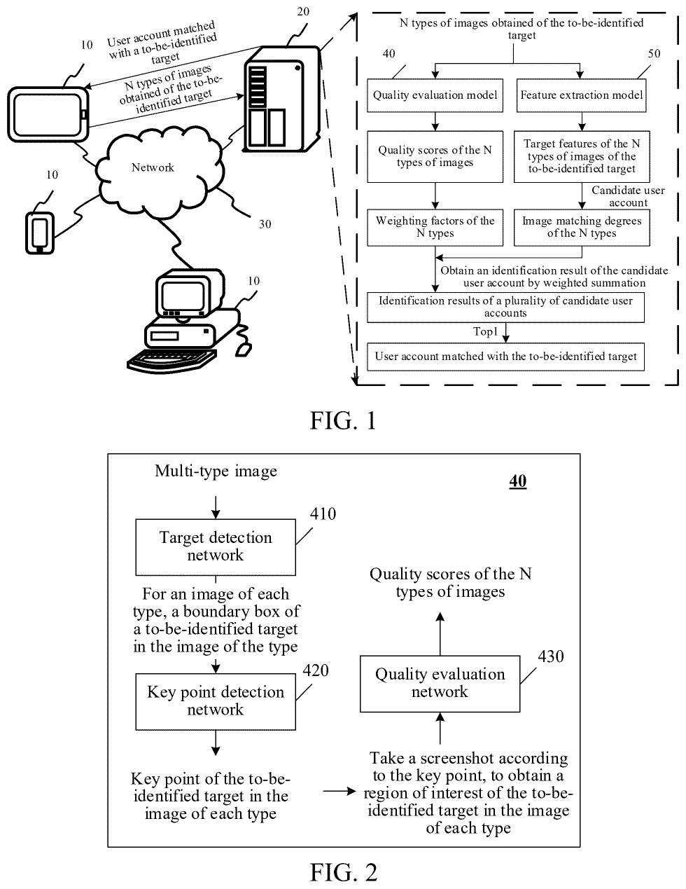

FIG. 1 is a schematic diagram of a solution implementation environment according to an aspect of this disclosure. The implementation environment may include: a terminal device 10 and a server 20.

The terminal device 10 may be, for example, a mobile phone, a tablet computer, a multimedia playing device, a personal computer (PC), an intelligent robot, an in-in-vehicle terminal, a gate control device, a payment device, a security inspection device, and any electronic device having an image obtaining function. A client of a target application program may be installed in the terminal device 10. The target application program may be, for example, a palm swiping authentication application program, a payment application program, a social entertainment application program, a simulation learning application program, or any application program having a target identification function.

The server 20 is configured to provide a background service for the client of the target application program (for example, a palm swiping authentication application program) in the terminal device 10. For example, the server 20 may be a background server of the above application program (e.g. a palm swiping authentication application program). The server 20 may be a server, or a server cluster composed of a plurality of servers, or a cloud computation service center.

The terminal device 10 may communicate with the server 20 through a network 30. The network 30 may be a wired network, or may be a wireless network.

For example, after obtaining N types of images (which may alternatively be referred to as multi-type images) for a to-be-identified target, the terminal device 10 transmits the N types of images to the server 20, and the server 20 determines, for each type (which is referred to as an i-th type) in the N types, a weighting factor of the i-th type according to an imaging quality of the image of the i-th type. The server 20 performs feature identification on the image of the i-th type through a feature extraction model 50, to determine a target feature of the i-th type, and performs a matching operation on the target feature of the i-th type and a candidate feature of the i-th type, to obtain an image matching degree of the i-th type. Later, the server 20 performs weighted summation on the image matching degrees of the N types according to the weighting factors of the N types, to obtain an identification result of a candidate user account. The server 20 then determines, according to the identification results, a user account (i.e. a final identification result) matched with the to-be-identified target. The server 20 transmits the final identification result to the terminal device 10. The terminal device 10 performs a corresponding operation according to the final identification result.

In some aspects, a quality evaluation model 40 and the feature extraction model 50 may be deployed in the terminal device 10, so that the terminal device 10 performs the process of obtaining the final identification result. The aspects of this disclosure do not limit this.

The quality evaluation model 40 may be a neural network model configured for evaluating an imaging quality of an image, and may output a quality score configured for evaluating the imaging quality of the image. The feature extraction model 50 is a neural network model configured for performing feature extraction on an image, and may output a target feature configured for representing a to-be-identified target in the image. The target feature is also referred to as a feature vector, which is a mathematical abstract expression of a target and may be configured for identifying the target. In some aspects, the feature extraction model 50 may be constructed and obtained based on, for example, a convolutional neural network (CNN), a backpropagation (BP) neural network, a GoogleNet (a deep learning structure), or a residual network (ResNet).

In an example, referring to FIG. 2, the quality evaluation model 40 may include a target detection network 410, a key point detection network 420, and a quality evaluation network 430. The target detection network 410 is configured to obtain a bounding box of a to-be-identified target in an image. The key point detection network 420 is configured to obtain a key point corresponding to the to-be-identified target. The quality evaluation network 430 is configured to obtain an imaging quality of the image with respect to the to-be-identified target. For example, after the target detection network 410 obtains the bounding box of the to-be-identified target in the image, the image is cropped through the bounding box, to obtain a cropped image. The key point monitoring network 420 is used to process the cropped image.

In some aspects, the target detection network 410 may be constructed based on a single shot detector (SSD, which is a target detection network), or may be constructed based on a you only look once (YOLO), or may be constructed based on another network such as a convolutional neural network (CNN), a region-CNN (R-CNN), and a faster R-CNN. The aspects of this disclosure do not limit this. The target detection network 410 may perform training based on a training sample with the to-be-identified target. The training sample includes an image of the to-be-identified target and labeled data of the to-be-identified target. Training data of the to-be-identified target may be determined according to use of the target detection network in actual working engineering. This disclosure does not limit this.

The key point detection network 420 may be constructed based on a network such as DeepPose (a convolutional neural network for key point detection), a deep neural network (DNN), or a high-resolution net (HRNet). The aspects of this disclosure do not limit this. The key point detection network 420 may be trained based on a training sample with labeled data of key points.

The quality evaluation network 430 may be constructed and obtained based on a network such as FaceQnet (a quality evaluation model for facial images), a CNN, or GoogleNet. The quality evaluation network 430 may be trained based on a training sample with labeled data of an imaging quality, or may be trained by using an identification score outputted by FaceQnet as labeled data. The aspects of this disclosure do not limit this.

Technical solutions provided in this disclosure will be described below through the aspects of the method.

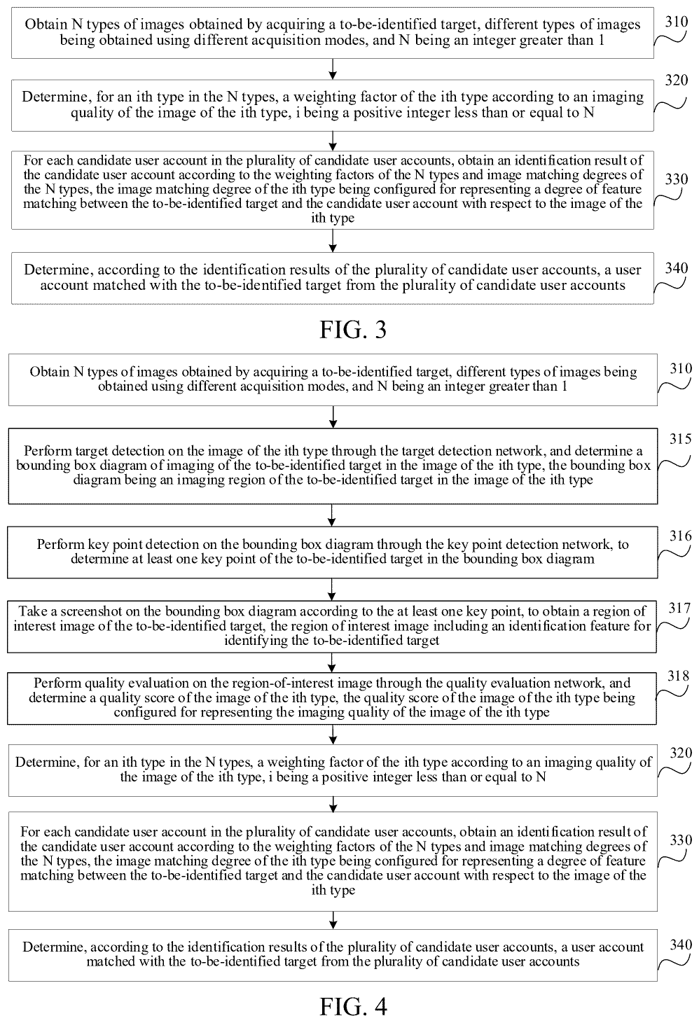

Referring to FIG. 3, it shows a flowchart of an identification result determination method according to an aspect of this disclosure. An executive agent of operations of the method may be the terminal device 10 or the server 20 in the implementation environment of the solution shown in FIG. 1. For ease of description, the following describes and explains this solution by using a computer device as an executive agent. The method may include several following operations (310 to 340).

Operation 310: Obtain N types of images obtained by acquiring a to-be-identified target, different types of images being obtained using different acquisition modes, and N being an integer greater than 1. For example, a plurality of images of a to-be-identified target is obtained. The plurality of images includes a plurality of types of images. Each type of the plurality of types of images is obtained using a different acquisition mode.

In some aspects, the to-be-identified target is an identified object in a target identification process. By determining an identification result of the to-be-identified target, a type of the to-be-identified target can be determined, or identity authentication on the to-be-identified target can be completed. The aspects of this disclosure do not limit the type of the to-be-identified target. For example, in a palm swiping authentication scenario, the to-be-identified target is a palm. For another example, in a face swiping payment scenario, the to-be-identified target is a face. A specific value of N is determined according to an actual identification requirement. This disclosure does not limit this value.

In some aspects, for the image of each type in the N types of images, a to-be-identified image is displayed in the image. The N types of images include at least two of the following: an infrared image, a color image, a depth image, a grayscale image, and the like. In some aspects, the N types of images include at least two types of images, and the at least two types of images are respectively obtained by acquiring a target object in different acquisition modes. An acquisition mode may be understood as a mode for photographing the to-be-identified target.

In some aspects, for an i-th type of the N types of images, the image of the i-th type includes k images, k being a positive integer. The k images are acquired in the same mode. For different types in the N types, quantities of images respectively included in the different types of images may be the same or different.

In some aspects, different acquisition modes are implemented through different acquisition sensors. In some aspects, the N types of images are obtained by performing image acquisition on the to-be-identified target by an image acquisition apparatus. For example, acquisition sensors for the N types are deployed in the image acquisition apparatus. An acquisition sensor for the i-th type in the acquisition sensors for the N types performs image acquisition on the to-be-identified target in an acquisition mode corresponding to the acquisition sensor for the i-th type, to obtain the image of the i-th type, i being a positive integer less than or equal to N.

For example, a maximum time interval between acquisition moments of a plurality of different acquisition sensors is less than or equal to an interval threshold. For example, the interval threshold is 0.5 second. If a sensor having an earliest collection moment in the acquisition sensors for the N types acquires a to-be-identified image at 12:00:00.00, a moment at which another acquisition sensor in the acquisition sensors for the N types acquires a to-be-identified target is not later than 12:00:00.05

In some aspects, the acquisition sensor for the i-th type in the acquisition sensors for the N types acquires the to-be-identified target for multiple times, selects first k images with best focusing degrees from images respectively obtained in the multiple acquisitions as the image of the i-th type, and transmits the k images to the computer device, k being a positive integer. For example, k is equal to 3.

For example, a palm swiping authentication scenario is taken as an example. The to-be-identified target is a to-be-identified palm, and an image acquisition device may be referred to as a palm swiping device. In this scenario, an infrared sensor and a color sensor are at least deployed on the palm swiping device, and the above N types of images include a color image and an infrared image. The infrared sensor in the palm swiping device obtains the infrared image by imaging flood infrared ray radiated from the to-be-identified palm. The color sensor in the palm swiping device obtains the color image by imaging natural light reflected by the to-be-identified palm. The infrared image may be configured for living body (for example, liveness) detection. For example, the infrared image includes a blood vessel distribution. The color image is also referred to as a red-green-blue (RGB) image, and the color image is configured for representing a texture distribution of the to-be-identified palm.

In some aspects, a wired connection or a wireless connection exists between the computer device and the image acquisition device. For example, when the computer device is a server, the image acquisition device transmits the N types of images to the server through the wireless connection by long-range wireless communication, to implement operation 310. For another example, the image acquisition device and the computer device are integrated into one device. After the image acquisition device acquires the to-be-identified target, the computer device can directly obtain the N types of images.

Operation 320: Determine, for an i-th type in the N types, a weighting factor of the i-th type according to an imaging quality of the image of the i-th type, i being a positive integer less than or equal to N. For example, for each type of image in the plurality of types of images, a weighting factor of the respective type of image is determined based on an image quality of the respective type of image.

The i-th type may be any type in the N types. For each type in the N types, the weighting factor of this type may be determined by using the method provided in operation 320. In some aspects, the imaging quality of the image of the i-th type is configured for measuring a clarity of the k images included in the image of the i-th type. A higher definition of the k images indicates a higher imaging quality of the image of the i-th type. In some aspects, a lower definition of the k images indicates a lower imaging quality of the image of the i-th type. In other words, the imaging quality of the image of the i-th type is configured for reflecting richness of details that are included in the image of the i-th type and are related to the to-be-identified target. Higher imaging quality of the image of the i-th type indicates that the image of the i-th type has recorded richer details related to the to-be-identified target.

In some aspects, the imaging quality of the image of the i-th type is related to factors such as a focusing degree of an i-th kind of acquisition mode in a process of acquiring the to-be-identified target, movement of the to-be-identified target, image acquisition performance (such as a resolution or an aperture size) of the acquisition sensor for the i-th type, and stability (whether swinging occurs) of the acquisition sensor for the i-th type. Since the imaging quality of the image has important impact on identification accuracy of a to-be-identified target, an image having an imaging quality helps to improve accuracy of identifying the to-be-identified target, and an image having a high imaging quality can provide less useful information in a target identification process. Therefore, before target identification, it can be beneficial to determine, according to the imaging qualities of the N types of images, contribution degrees of different types of images in the to-be-identified target identification process.

In some aspects, the imaging quality of the image of the i-th type is predicted according to at least one image included in the image of the i-th type according to a quality evaluation model. For example, the at least one image included in the image of the i-th type is inputted to the quality evaluation model, and an imaging quality of the at least one image is evaluated through the quality evaluation model. For example details of this operation, reference can be made to the following aspects.

In some aspects, the imaging quality of the image of the i-th type may be measured according to a smoothness degree between adjacent pixel points in the at least one image included in the image of the i-th type. A larger smoothness value indicates a higher imaging quality of an image. A smaller smoothness value indicates a lower imaging quality of an image. For example, for any image in the at least one image, a pixel value difference between two adjacent pixel points of the image in a positive direction of an x axis of an image coordinate system is determined. Pixel value differences, greater than or equal to a pixel threshold, in the plurality of pixel value differences are summed to obtain a smoothness value. The smoothness value is used to represent the image quality of the image.

In this aspect of this disclosure, the weighting factor is used for indicating a participation degree of the image in the to-be-identified target identification process. Namely, a weighting factor of a type determines a contribution degree of an image of the type to an identification result. The N types include at least two types. The weighting factors of the two types have different values. In some aspects, a sum of the weighting factors of the N types is equal to 1.

In some aspects, for the i-th type in the N types, a value of the weighting factor of the i-th type is in positive correlation with the imaging quality of the image of the i-th type. For example, a higher imaging quality of the image of the i-th type indicates a larger value of the weighting factor of the i-th type. A lower imaging quality of the image of the i-th type indicates a smaller value of the weighting factor of the i-th type.

Operation 330: For each candidate user account in the plurality of candidate user accounts, obtain an identification result of the candidate user account according to the weighting factors of the N types and image matching degrees of the N types, the image matching degree of the i-th type being configured for representing a degree of feature matching between the to-be-identified target and the candidate user account with respect to the image of the i-th type. For example, for each candidate user account of a plurality of candidate user accounts, an identification result associated with the respective candidate user account is obtained based on the weighting factors of the plurality of types of images and image matching degrees of the plurality of types of images. The image matching degree of each of the plurality of types of images indicates a degree of feature matching between the to-be-identified target and the respective candidate user account based on the respective type of image.

The plurality of candidate user accounts includes a candidate user account, and the to-be-identified target is from a user to which the candidate user account belongs. An objective of identifying the to-be-identified target is to find the candidate user account from the plurality of candidate user accounts according to the to-be-identified target. In some aspects, the candidate user account is a user account that completes registration in a target application program, and one user account corresponds to one user. In operation 330, the computer device respectively determines identification results for the to-be-identified target and the plurality of candidate user accounts, to determine, according to the identification results, a user account corresponding to a user to which the to-be-identified target belongs. For example details, reference can be made to the following aspects.

In some aspects, the image matching degree of the i-th type is configured for measuring a similarity between the image of the i-th type of the to-be-identified target and the image of the i-th type of image of the candidate user account.

In some aspects, for each user account in the candidate user accounts, to determine the image matching degree of the i-th type between the candidate user account and the to-be-identified target, information configured for describing the image of the i-th type of the to-be-identified target and information configured for describing the image of the i-th type of the candidate user account is used.

For example, the image of the i-th type of the to-be-identified target is obtained in operation 310 described above, and the information configured for describing the image of the i-th type of the to-be-identified target is obtained by processing the image of the i-th type of the to-be-identified target.

For example, the image of the i-th type of the candidate user account is obtained by acquiring a user target provided by the user to which the candidate user account belongs. The image of the i-th type of the candidate user account may be uploaded to the computer device by the candidate user account in advance, so that the computer device processes the image of the i-th type of the candidate user account, to obtain the information configured for describing the image of the i-th type of the candidate user account. The information configured for describing the image of the i-th type of the candidate user account may be predetermined and stored in a database.

The user target provided by the user and the to-be-identified target belong to the same type. For example, the to-be-identified target and the user target provided by the user are both palms. Namely, the user target is a palm of the user. For another example, the to-be-identified target and the user target provided by the user are both pupils.

In some aspects, for a candidate user account, after the image matching degrees of the N types between the candidate user account and the to-be-identified target are determined, the computer device determines the identification result of the candidate user account according to the image matching degrees of the N types and the weighting factors of the N types. The identification result of the candidate user account may be represented by a decimal within a range [0, 1]. In some aspects, in the process of determining an identification result of a candidate user account, for the i-th type in the N types, the image matching degree of the i-th type is processed by using the weighting factor of the i-th type, to obtain the processed image matching degree of the i-th type. The processed image matching degree of the i-th type participates in the process of determining the identification result of the candidate user. For an example of this operation, reference can be made to the following aspects.

Since an imaging factor of the i-th type is related to the imaging quality of the image of the i-th type, and they are in positive correlation to each other. A type with a good imaging quality has a larger weighting factor, so that the image of this type has a great contribution to the process of determining the identification result, so as to make full use of detailed information provided by the image of the type with the good imaging quality in the target identification process, reduce interference of meaningless information in an image of an type with a poor imaging quality to the identification result, and reduce introduction of incorrect information into the target identification process, thereby helping improve accuracy of the identification result.

After the identification results of the plurality of candidate user accounts are determined, operation 330 is completed. In addition, the processes of determining the identification results of the plurality of candidate user accounts may be performed in series or in parallel. For example, the computer device determines the identification results of the plurality of candidate user accounts one by one. For another example, in a case that a calculation performance of the computer device permits, in operation 330, the computer device establishes a plurality of progresses. The different processes are respectively configured for calculating identification results of different candidate user accounts. This mode helps increase a speed of performing target identification, reduce time consumption of determining the identification results of the plurality of candidate user accounts, and reduce waiting time of a user.

Operation 340: Determine, according to the identification results of the plurality of candidate user accounts, a user account matched with the to-be-identified target from the plurality of candidate user accounts. For example, based on the identification results of the plurality of candidate user accounts, the user account that matches the to-be-identified target is determined from the plurality of candidate user accounts.

In some aspects, the computer device determines, from the identification results of the plurality of candidate user accounts, a candidate user account corresponding to an identification result having a largest value as the user account matched with the to-be-identified target. For example, it is determined that the to-be-identified target is provided by the user to which the user account matched with the to-be-identified target belongs.

In some aspects, that the computer device determines, according to the identification results of the plurality of candidate user accounts, a user account matched with the to-be-identified target from the plurality of candidate user accounts includes: The computer device determines, according to the identification results of the plurality of candidate user accounts and a determination threshold, the user account matched with the to-be-identified target. If the identification result having the largest value in the identification results of the plurality of candidate user accounts is greater than or equal to the determination threshold, the candidate user account corresponding to the identification result having the largest value is determined to be the user account matched with the to-be-identified target.

For example, if the identification results of the plurality of candidate user accounts are all less than the determination threshold, it is determined that the user account matched with the to-be-identified target does not exist in the plurality of candidate user accounts. The determination threshold is determined in advance. For example, the determination threshold is equal to 0.95.

In conclusion, after the plurality of different types of images of the to-be-identified target are obtained, the weighting factors of the types of images are determined according to the imaging qualities respectively corresponding to the plurality of different types of images, and then the user account matched with the to-be-identified target is determined based on the weighting factors of the types of images and with reference to the types of images, so that in the aspects of this disclosure, the weighting factors of the types of images are properly and accurately allocated, thereby improving the accuracy of the identification result and improving the target identification accuracy. Especially in a scenario with complex light, by allocating the weighting factors of the types of images properly and accurately, an image with a good imaging quality has high impact on an identification result, and an image with a poor imaging quality has low impact on an identification result, thereby improving the target identification accuracy.

The following will introduce and explain a method for determining the weighting factors of different types in the N types through several aspects.

In some aspects, operation 320 of determining a weighting factor of the i-th type according to an imaging quality of the image of the i-th type includes the following several operations, and the following several operations are performed by the computer device.

Operation 321: Determine a quality score of the image of the i-th type, the quality score of the image of the i-th type being configured for representing the imaging quality of the image of the i-th type.

In some aspects, the foregoing quality score is obtained by evaluating image content of the image of the i-th type, namely, the foregoing quality score may be configured for representing a clarity and imaging quality of a corresponding region of the to-be-identified target in the image of the i-th type. In some aspects, the quality score is configured for evaluating the imaging quality of the to-be-identified target in the image. In some aspects, a higher quality score indicates a higher imaging quality of the to-be-identified target in the image, namely, the to-be-identified target is imaged more clearly in the image of the i-th type, and the image of the i-th type includes more details about the to-be-identified target. A lower quality score indicates a lower imaging quality of the image of the i-th type, namely, the to-be-identified target is imaged blurrily in the image, and the image may not show details of the to-be-identified target. This helps improve the to-be-identified target identification accuracy.

The quality score of the image of the i-th type may be determined through a quality evaluation model, or may be obtained by evaluating pixel values of pixel points in the image through a smoothness value or the like. For an example of the quality evaluation model and the smoothness value, reference can be made to the foregoing aspect, and details are not elaborated here again.

In some aspects, in a case that the image of the i-th type includes k images, and k is greater than 1, the operation of determining a quality score of the image of the i-th type includes: respectively determining quality scores of the k images, and determining the quality score of the image of the i-th type according to the quality scores of the k images. For any image in the k images, the quality score of the image may be determined through the quality evaluation model or the smoothness value. For example details, reference can be made to the above text.

For example, the computer device performs weighted summation on the quality scores of the k images, to obtain the quality score of the image of the i-th type. For example, the computer device determines, according to the quality scores of the k images, m images having highest quality scores from the k images, and performs weighted summation on the quality scores of the m images, to obtain the quality score of the image of the i-th type, m being a positive integer less than or equal to k.

Operation 323: Determine a weight representation parameter of the i-th type according to a value relationship between the quality score of the image of the i-th type and a quality score threshold, the weight representation parameter of the i-th type being configured for controlling a degree of impact of the image of the i-th type to the identification result.

In some aspects, the quality score threshold is a reference value used when the weight representation parameter of the i-th type is determined based on the quality score of the image of the i-th type. In some aspects, the quality score threshold of the i-th type is in positive correlation to the weighting factor of the i-th type. For example, a larger value of the quality score threshold of the i-th type indicates a larger value of the weighting factor of the i-th type. A smaller value of the quality score threshold of the i-th type indicates a smaller value of the weighting factor of the i-th type.

In some aspects, the N types include at least two different types, and the quality score thresholds of the two types are not equal. For example, for the i-th type in the N types, the quality score threshold of the i-th type is determined according to an image capture capability of an i-th acquisition sensor. Determining the quality score threshold of the i-th type by this mode helps improve an adaptability of the weighting factor to acquisition sensors having different acquisition capabilities, which helps improve the accuracy of determining the value of the weighting factor, and further improves the accuracy of the target identification process.

In some aspects, different types of images may share the same quality score threshold. In this way, a quantity of quality score thresholds can be reduced, thereby reducing a complexity of determining the weighting factor.

In an example, a quality score threshold is preset, and the computer device stores quality score thresholds of the N types. In another example, a quality score threshold is obtained in real time. In a case that the computer device is a server, the server may receive, within the same time period, the N types of images respectively obtained by acquiring a plurality of to-be-identified targets. The plurality of to-be-identified targets may be acquired by different image acquisition apparatuses. If the quality score thresholds of the N types respectively set for different image acquisition apparatuses are stored in advance, the server has a high storage load.

In this case, when transmitting, to the server, the N types of images acquired by the image acquisition apparatuses, the image acquisition apparatuses may further transmit acquisition performance parameters of the acquisition sensors for the N types included in the image acquisition apparatuses to the server, so that the server respectively determines the quality score thresholds of the N types according to the acquisition performance parameters of the acquisition sensors. This mode is conductive to reducing the storage load of the server for storing the quality score thresholds. In addition, determining the quality score parameters of the types in real time according to the acquisition performance parameters of the acquisition sensors is conductive to improving the adaptability of the target identification process to different scenarios.

Considering that the imaging quality obtained by using a feature identification algorithm in this aspect of this disclosure has a robustness, for example, after the imaging quality of the image of the i-th type and imaging quality of an image of a j-th type both reach a level (i.e. the imaging quality is good), a difference between the imaging quality of the image of the i-th type and the imaging quality of the image of the j-th type has little impact on the identification result. Therefore, when the imaging quality of an image of a type reaches a level (e.g. a quality score of the image of this type is greater than or equal to a quality score threshold), the impact of the imaging quality of the image of this type on a weighting factor of the type is reduced, and even the weighting factor of this type does not change any more.

In some aspects, a quality score threshold may be set and adjusted according to an empirical value. This process will be introduced and explained by taking an example in which a first type and a second type included in the N types share the same quality score threshold is taken, an example in which an image of the first type is a color image, and an example in which an image of the second type is an infrared image. In a process of determining a quality score threshold, an image acquisition apparatus is used to sample the same target to obtain a plurality of groups of sample images. Each group of sample images includes a high-quality color image and a high-quality infrared image; an initial score threshold is set; and operations 320 to 340 above are performed, to maximize an identification result corresponding to each group of sample images as a target. A quality score threshold corresponding to each group is adjusted, to adjust a weighting factor. In a case that the identification result corresponding to each group of sample images tends to be stable, the quality score threshold currently corresponding to each group of sample images is determined to be a final quality score threshold of this group of sample images. The quality score threshold shared by the first type and the second type may be obtained by averaging the final quality score thresholds respectively corresponding to the groups of sample images.

In some aspects, the computer device selects, according to the value relationship between the quality score of the image of the i-th type and the quality score threshold of the i-th type, one of the quality score of the image of the i-th type and the quality score threshold as the weight representation parameter of the i-th type. In an example, the quality score mentioned in operation 321 may be obtained through operations 315 to 318 in the following aspects.

In some aspects, operation 323 may be implemented in any one of the following modes.

Mode 1: A smaller value is determined from the quality score of the image of the i-th type and the quality score threshold to be the weight representation parameter of the i-th type.

For example, the process of obtaining the weight representation parameter of the i-th type is determined using formula min (Q, A), where Q is the quality score of the image of the i-th type, and A is the quality score threshold of the i-th type.

Mode 2: A larger value is determined from the quality score of the image of the i-th type and the quality score threshold to be the weight representation parameter of the i-th type.

For example, the process of obtaining the weight representation parameter of the i-th type is determined using formula max (Q, A), where Q is the quality score of the image of the i-th type, and A is the quality score threshold. In this way, for a type with a low imaging quality, the quality score threshold is used as the weight representation parameter of the type, to avoid that a too small weight representation parameter of the type causes the image matching degree of the type has a small contribution to the identification result, and causes the calculation process of determining the image matching degree of the type to become meaningless.

Mode 3: A mean value of the quality score of the image of the i-th type and the quality score threshold is determined to be the weight representation parameter of the i-th type. In the process of determining the weight representation parameter of the i-th type, a weighting factor of the quality score of the image of the i-th type and a weighting factor of the quality score threshold may be equal or not equal. This disclosure does not limit this.

For example, the quality score of the image of the i-th type and the quality score threshold of the i-th type are not equal. The mean value of the quality score of the image of the i-th type and the quality score threshold is determined to be the weight representation parameter of the i-th type, which is conductive to properly reducing the contribution degrees of various types of images to the identification results of the candidate user accounts due to the imaging quality in the process of determining the quality score threshold, helping a plurality of types of images participate in the target identification process, and providing different types of reference information for the target identification process, thereby helping ensure accuracy of the target identification process in multiple aspects.

Operation 325: Perform weighting factor calculation according to the weight representation parameter of the i-th type, to obtain the weighting factor of the i-th type.

In some aspects, the computer device performs the weighting factor calculation according to the weight representation parameter of the i-th type by using a linear weight adjustment formula, to obtain the weighting factor of the i-th type. The weighting factor calculation is a process of determining the weighting factor of the i-th type according to a weight representation of the i-th type. For example, the weighting factor calculation process needs to use the weight representation parameters of the N types.

In some aspects, operation 325 is implemented by using the following several steps. An executive agent for the following steps is the computer device.

Operation 325-a: Sum the weight representation parameters of the N types, to obtain a summation result.

For example, a summation result is calculated by using a formula Σᵢ₌₁ⁿ cᵢ, where cᵢ indicates the weight representation parameter of the i-th type.

In some aspects, in the process that the computer device determines the weighting factors of the N types, operation 325-a is performed for less than N times. For example, operation 325-a is necessary for the process of determining the weighting factor of a third type in the weighting factors of the N types. The third type is a type in the N types, the weighting factor of which is determined earliest. In an actual execution process, the third type may be a type selected in various manners from the N types.

For example, for another type in the N types except the third type, operation 325-a is not necessary in the process of determining the weighting factor of the another type. For example, after determining the summation result in the process of determining the weighting factor of the third type, the computer device stores a value of the summation result. During determination of the weighting factor of the another type, the summation result is directly read from a storage space, instead of performing operation 325-a.

Operation 325-b: Calculate a ratio of the weight representation parameter of the i-th type to the summation result, to obtain the weighting factor of the i-th type.

In some aspects, the weighting factor of the i-th type is in positive correlation with the weight representation parameter of the i-th type, and the weighting factor of the i-th type is in negative correlation with the summation result.

In an example, an example of the N types including a first type and a second type, an image of the first type being a color image, an image of the second type being an infrared image, a plurality of different types of images including a color image and an infrared image, and quality score thresholds of the first type and the second type being equal is taken. A weighting factor α of the first type is calculated by using the following formula:

$$α = \frac{min ( {Q}_{r} , A )}{min ( {Q}_{r} , A ) + min ( {Q}_{i} , A )}$$

where Qᵣ represents a quality score of the image of the first type; Qᵢ represents a quality score of the image of the second type; and A is a quality score threshold. It can be known from the foregoing content that if a sum of the weighting factors of the N types of images is 1, a weighting factor β of the second type is denoted as β=1−α, or denoted as:

$$β = \frac{min ( {Q}_{i} , A )}{min ( {Q}_{r} , A ) + min ( {Q}_{i} , A )}$$

For examples of meanings of the parameters in the formula, reference can be made to the foregoing description, and details will not be limited here.

In this way, the weight representation parameters of the plurality of types are determined according to the quality scores of the plurality of types of images, and the weighting factors of the plurality of types are determined based on the weight representation parameters, so that the imaging qualities of the different types of images is considered in the process of determining the weighting factors, and a type having a high imaging quality has a greater contribution to the process of determining the identification result. Since an image having a high imaging quality can provide more information about the to-be-identified target in the target identification process, this aspect of this disclosure helps improve the accuracy of the target identification process.

In addition, the weight representation parameters corresponding to the different types of images are determined according to the value relationships between the quality scores and the quality score thresholds. Then, the weighting factors corresponding to the different types of images are determined according to the weight representation parameters corresponding to the different types of images, so that the weighting factors better meet true impact relationships between the quality scores and the identification results, thereby improving properness of determining the weighting factors, and further improving the target identification accuracy. In addition, in the technical solution provided in this aspect of this disclosure, the weighting factors can be dynamically adjusted according to the quality of the images, so that the technical solution provided in this aspect of this disclosure is applicable to different light environments, thereby improving the practicability and an anti-interference capability of the technical solution provided in this aspect of this disclosure.

The following will introduce and explain a method for determining the quality score of the i-th type through several aspects. FIG. 4 is a flowchart of an identification result determination method according to another aspect of this disclosure. An executive agent of this aspect is a computer device. Referring to FIG. 4, the identification result determination method may include the following several operations.

Operation 310: Obtain N types of images obtained by acquiring a to-be-identified target, different types of images being obtained using different acquisition modes, and N being an integer greater than 1. For example, a plurality of images of a to-be-identified target is obtained. The plurality of images includes a plurality of types of images. Each type of the plurality of types of images is obtained using a different acquisition mode. For an example of operation 310, reference can be made to the above text.

After the execution of operation 310 is completed, the computer device needs to respectively determine weighting factors of the various types according to imaging qualities of the various types of images. In some aspects, in this aspect, a quality score of an image of an i-th type is determined through a quality evaluation model. The quality evaluation model includes a target detection network, a key point detection network, and a quality evaluation network. The computer device determines the imaging qualities of the N types of images by using the quality evaluation model. In some aspects, the imaging qualities of the different types of images are determined using the same quality evaluation model.

In some aspects, the imaging qualities of the different types of images are determined using different quality evaluation models. For example, the different quality evaluation models include: quality evaluation models with different model structures, or quality evaluation models with the same model structures but different model parameters. In this aspect of this disclosure, principles that different types of quality evaluation models are used to determine the imaging qualities of the different types of images are similar. The following will introduce and explain this process by taking determination of the imaging quality of the image of the i-th type as an example.

Operation 315: Perform target detection on the image of the i-th type through the target detection network, to determine a bounding box image of imaging of the to-be-identified target in the image of the i-th type, the bounding box image being an imaging region of the to-be-identified target in the image of the i-th type. For example, target detection is performed on the image of one of the plurality of types of images via the target detection network to determine a bounding box image of the to-be-identified target in the image. The bounding box image indicates an imaging region of the to-be-identified target in the image.

In some aspects, the bounding box image in the image of the i-th type is configured for distinguishing a display region of the to-be-identified target from a display region of another image content in the image of the i-th type. For example, the bounding box image in the image of the i-th type includes all pieces of image content related to the to-be-identified target in the image of the i-th type. For example, the bounding box image is a rectangular region in the image of the i-th type.

In some aspects, the computer device performs the target detection on the image of the i-th type through the target detection network, to obtain a bounding box of the to-be-identified target in the image of the i-th type, and takes a screenshot of a region corresponding to the bounding box on the image of the i-th type, thus obtaining the bounding box image.

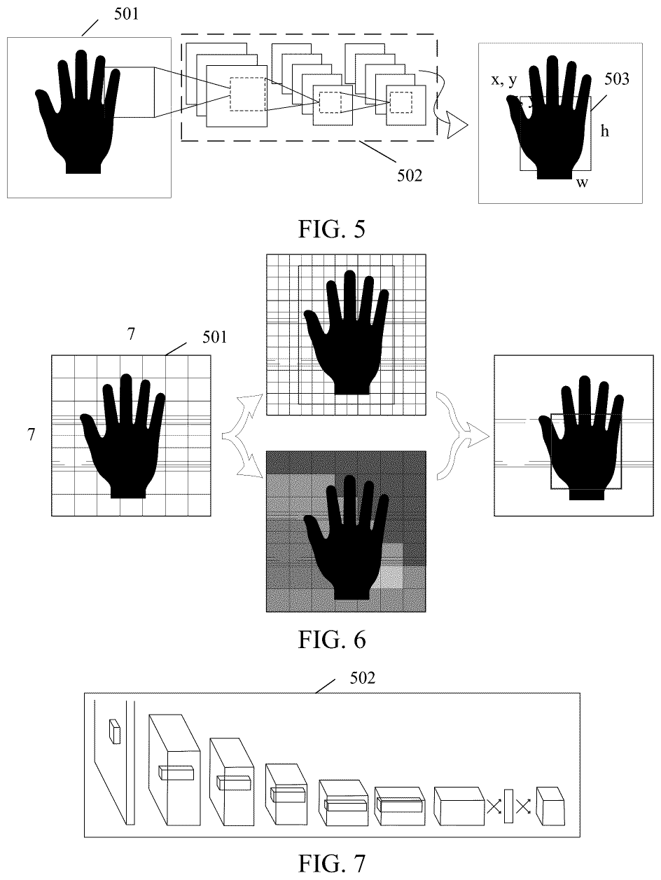

Referring to FIG. 5, an execution process of operation 316 is introduced by taking a palm swiping scenario as an example. For an image 501 of the i-th type in the N types of images, the image 501 of the i-th type is first inputted to a target detection network 502. The target detection network 502 divides the image 501 of the i-th type into S*S grids, and respectively performs boundary prediction on each grid in the S*S grids, to obtain prediction results of the S*S grids. The process of performing the boundary prediction on any grid includes: predicting the grid for B bounding boxes, to obtain predicted information of the B bounding boxes, where the prediction result of the grid includes the predicted information of the B bounding boxes, and B is a positive integer greater than 1. Sizes of frame regions of the B bounding boxes are not equal. Usually, a bounding box is a rectangular box.

The predicted information of each bounding box in the B bounding boxes includes five predicted values, which are respectively: x, y, w, h, and a confidence, where x and y represent angular coordinates of a plane-coordinate system of a center point of the bounding box; value ranges of x and y may be adjusted by normalization to 0-1; w and h represents sizes of the bounding box (e.g. including a width and height of the bounding box); and value ranges of w and h are adjusted by normalization to 0-1.

In some aspects, normalization performed on x is implemented as dividing an original value of x by the width w of the bounding box, to obtain a predicted value x; and normalization performed on y is implemented as dividing an original value of y by the height h of the bounding box, to obtain a predicted value y.

The confidence is configured for representing a possibility that the bounding box displays a complete palm or a part of a palm in an image region corresponding to the image of the i-th type.

For example, each grid predicts a probability of C assumed types, and the target detection network 502 outputs a tensor with a prediction result of S*S*(B*5+C). For example, referring to FIG. 6, an image 501 is divided into 7*7 grids, namely, S=7. Each grid corresponds to two bounding boxes, namely, B=2. If there are 20 assumed types in total, namely, C=20, a prediction result of the target detection network 502 is a tensor with a prediction result of 7*7*30.

In some aspects, a calculation formula of the confidence may be as follows:

Pr*IOU_{pred}^{truth}
where Pr is configured for representing whether a palm exists in the corresponding grids (if yes, Pr=1; if no, Pr=0). IOU_{pred}^{truth} is an intersection-union ratio of a palm bounding box outputted by the target detection network 502 and a real palm bounding box. If there is no palm in the grids, the confidence is 0. If there is a palm in the grids, the confidence is the intersection-union ratio of the palm bounding box outputted by the target detection network 502 and the real palm bounding box.

In some aspects, the target detection network 502 mainly performs feature extraction by using GoogleNet. For example, referring to FIG. 7, the target detection network 502 includes a convolutional layer and a fully connected layer. The convolutional layer is configured to extract features of the image 501. For example, feature vectors in dimensions of 448*448*3, 112*112*192, 56*56*256, 28*28*512, 14*14*1024, 7*7*1024, and 7*7*1024 may be obtained in sequence. The fully connected layer is configured to predict a class, a coordinate, a size, a confidence, and the like based on the features outputted by the convolutional layer. For example, feature vectors in dimensions of 4096 and 7*7*30 dimensions may be obtained in sequence.

In some aspects, in the palm swiping scenario, the target detection network 502 includes only an assumed type of a palm, a bounding box having a maximum confidence may be determined to be a palm bounding box, such as a bounding box 503 in FIG. 5. The bounding box 503 may be configured for representing a position of the palm in the image 501; (x, y) represent a pixel position at an upper left corner of the bounding box 503; and (w, h) represent a width and height of the bounding box 503.

Operation 316: Perform key point detection on the bounding box image through the key point detection network, to determine at least one key point of the to-be-identified target in the bounding box image. For example, key point detection is performed on the bounding box image via the key point detection network to determine at least one key point of the to-be-identified target in the bounding box image.

Image content of the to-be-identified target in the image can be effectively obtained through the target detection network, which helps effectively avoid impact of irrelevant content on identification of the to-be-identified target, thereby improving the target identification accuracy. However, in the image acquisition process, since a position and angle between the to-be-identified target and the image acquisition apparatus change, the image is distorted, and sizes of bounding box images at different distances may be inaccurate. Therefore, in this aspect of this disclosure, the key point corresponding to the to-be-identified target is further obtained through the key point detection network, to further process the bounding box images, and avoid impact of a sampling position, a sampling angle, and the like on the target identification accuracy.

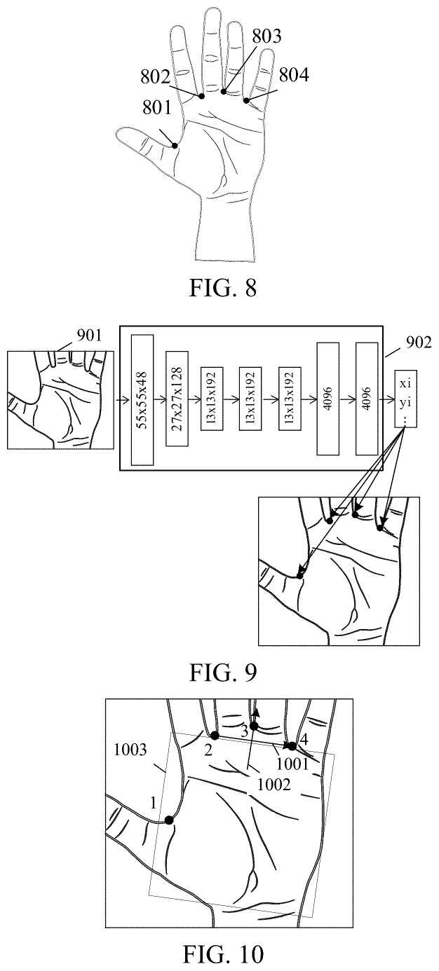

The key point may be a point that is relatively stationary on the to-be-identified target and may be configured for indicating the position of the to-be-identified target. For example, referring to FIG. 8, a palm is taken as an example. Valley points between fingers may be determined to be at least one key point corresponding to the palm, namely, key point 801, key point 802, key point 803, and key point 804.

For example, referring to FIG. 9, a bounding box image 901 (e.g. a dimension of which is 220*220) is inputted to a key point detection network 902. The key point detection network 902 performs key point detection on a palm in the bounding box image 901, to obtain at least one key point corresponding to the palm. For example, the key point detection network 902 performs a series of convolutional processing on the bounding box image 901, for example, performs convolutional processing in dimensions of 22*55*48, 27*27*128, 13*13*192, and 13*13*192 in sequence, and then predicts positions of the key points through two fully connected layers (for example, dimensions of which are both 4096), to output predicted coordinates of the at least one key point in the bounding box image 901.

To solve the problem that a size of a bounding box image is uncertain and the key point detection network 902 receives only an input of a specified size, a bounding box image that does not satisfy the specified size needs to be scaled. In this way, there may be an error in predicted coordinates of a key point because of the scaling performed on the bounding box image (if a boundary box has a large size, a bounding box image needs to be scaled to the specified size). In this aspect of this disclosure, a screenshot image with the specified size may be taken from the bounding box image according to the predicted coordinates of the key point, and then the key point detection is performed on the screenshot image through the key point detection network 902, to obtain a final predicted position corresponding to the key point. In this way, the key point extraction accuracy is improved, thereby improving the target identification accuracy.

Operation 317: Take a screenshot on the bounding box image according to the at least one key point, to obtain a region-of-interest image of the to-be-identified target, the region-of-interest image including an identification feature for identifying the to-be-identified target. For example, a region-of-interest image of the to-be-identified target is obtained based on the at least one key point. The region-of-interest image includes an identification feature or identifies the to-be-identified target.

The region-of-interest image may be an image obtained by taking a screenshot on image content of a corresponding region in the bounding box image according to a region of interest (ROI) corresponding to the to-be-identified target. For example, a palm is taken as an example. A region of interest of the palm may be a region with a palm print in the palm, and the region-of-interest image of the palm is a screenshot corresponding to a palm print region in a palm bounding box.

In some aspects, the computer device determines a smallest circumscribed box surrounding at least one key point, and cuts off an image outside the smallest circumscribed box in the bounding box image, so a remaining portion is the region-of-interest image.

Operation 318: Perform quality evaluation on the region-of-interest image through the quality evaluation network, to determine a quality score of the image of the i-th type, the quality score of the image of the i-th type being configured for representing the imaging quality of the image of the i-th type. For example, quality evaluation is performed on the region-of-interest image via the quality evaluation network to determine a quality score of the image. The quality score of the image indicates the image quality of the image.

In some aspects, in a case that the image of the i-th type includes k images, and k is greater than 1, for each image in the k images, operations 315, 316, 317, and 318 are respectively performed. After the imaging qualities of the k images are determined, the imaging quality of the image of the i-th type is determined according to the imaging qualities of the k images. For an example of this operation, reference can be made to the foregoing aspect, and details will not be described here again.

Operation 320: Determine, for an i-th type in the N types, a weighting factor of the i-th type according to an imaging quality of the image of the i-th type, i being a positive integer less than or equal to N. For example, for each type of image in the plurality of types of images, a weighting factor of the respective type of image is determined based on an image quality of the respective type of image.

Operation 330: For each candidate user account in the plurality of candidate user accounts, obtain an identification result of the candidate user account according to the weighting factors of the N types and image matching degrees of the N types, the image matching degree of the i-th type being configured for representing a degree of feature matching between the to-be-identified target and the candidate user account with respect to the image of the i-th type. For example, for each candidate user account of a plurality of candidate user accounts, an identification result associated with the respective candidate user account is obtained based on the weighting factors of the plurality of types of images and image matching degrees of the plurality of types of images. The image matching degree of each of the plurality of types of images indicates a degree of feature matching between the to-be-identified target and the respective candidate user account based on the respective type of image.

Operation 340: Determine, according to the identification results of the plurality of candidate user accounts, a user account matched with the to-be-identified target from the plurality of candidate user accounts. For example, based on the identification results of the plurality of candidate user accounts, the user account that matches the to-be-identified target is determined from the plurality of candidate user accounts.

For examples of content of operations 320, 330, and 340, reference can be made to the foregoing aspect, and details will not be described here again.

The quality evaluation is performed on the region-of-interest image of the to-be-identified target through the quality evaluation model, so that the imaging quality of the to-be-identified target can be accurately reflected. Then, the quality evaluation model is trained based on the region-of-interest image, so that the quality evaluation model can avoid impact of invalid data, thereby improving the quality score obtaining accuracy, and further improving the target identification accuracy.

The following will introduce and explain the process of obtaining the region-of-interest image through several aspects. In some aspects, operation 317 may be implemented by using the following several sub-operations. An executive agent for the several sub-operations is the computer device.

Sub-operation 317-a: Determine a screenshot size and a screenshot position for the region-of-interest image according to the at least one key point of the to-be-identified target in the bounding box image.

In some aspects, a reference coordinate system is constructed based on the at least one key point, and then a screenshot size and a screenshot position for the region-of-interest image are determined according to the at least one key point according to a set distance criterion. The set distance criterion is related to the to-be-identified target, and may be set and adjusted according to an empirical value. For example, referring to FIG. 10, an x-axis 1001 of the reference coordinate system is constructed by using a connecting line between key point 2 and key point 4; a y-axis 1002 of the reference coordinate system is then constructed by using a vertical line of the x-axis 1001; a value that is twice a distance between key point 2 and key point 4 is used as the screenshot size (if the region-of-interest image is a square, the screenshot size is a size of an edge of the region-of-interest image); and an original center of the reference coordinate system is used as the screenshot position.

Sub-operation 317-b: Perform position adjustment on the screenshot position of the region-of-interest image, to obtain an adjusted screenshot position of the region-of-interest image, where an overlapping degree of the to-be-identified target in the region-of-interest image with the screenshot size and the adjusted screenshot position, and the to-be-identified target in the bounding box image satisfies a first condition.

After the screenshot size of the region-of-interest image is determined, the screenshot position of the region-of-interest image may be adjusted, so that the region-of-interest image covers identification features of the to-be-identified target as many as possible. For example, referring to FIG. 10, after the region of interest corresponding to the palm is adjusted in a manner of rotation, translation, or the like, the region of interest 1003 at the adjusted screenshot position may be obtained. An overlapping degree of the region of interest 1003 at the adjusted screenshot position and the to-be-identified target is greater than an overlapping degree threshold, and the overlapping degree threshold may be set and adjusted according to an empirical value.

Sub-operation 317-c: Take a screenshot of an initial region-of-interest image on the bounding box image according to the screenshot size and the adjusted screenshot position.

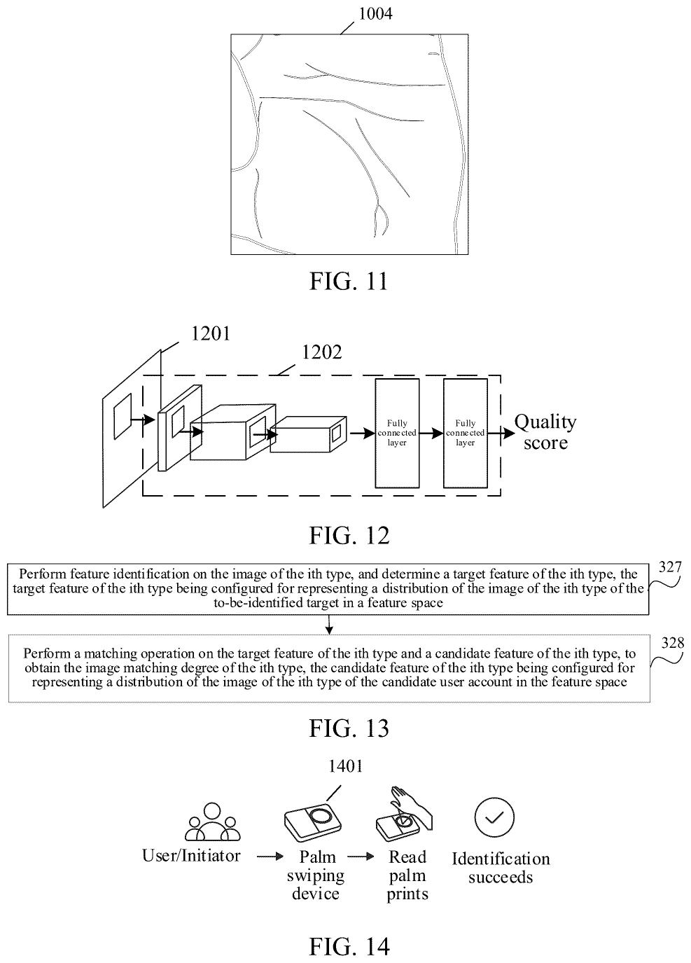

Referring to FIG. 10, image content corresponding to the region of interest 1003 is taken from the bounding box image, to obtain an initial region-of-interest image, such as, an initial region-of-interest image 1004 in FIG. 11.

Sub-operation 317-d: Scale the initial region-of-interest image to obtain the region-of-interest image.

In some aspects, the size of the initial region-of-interest image is scaled to a size required by an input of the quality evaluation network, to obtain the region-of-interest image.

For example, referring to FIG. 12, a region-of-interest image 1201 (for example, a corresponding dimension is 224*224*3) is inputted to a quality evaluation network 1202. The quality evaluation network 1202 performs quality evaluation on the region-of-interest image 1201, to obtain a quality score of an image corresponding to the region-of-interest image 1201. For example, a convolutional layer, a residual layer (e.g. ResNet-50), and a fully connected layer (a fully connected layer in a dimension of 2048+a fully connected layer in a dimension of 32) in the quality evaluation network 1202 process the region-of-interest image 1201 in sequence, to obtain the quality score (e.g. a corresponding dimension is 1) of the image corresponding to the region-of-interest image 1201.

In some aspects, for different types of images, quality evaluation may be performed through a quality evaluation network obtained by training the different types of images, to improve the quality score obtaining accuracy. Classifiers for the different types of images may be deployed in the quality evaluation network, to obtain the quality scores of the different types of images. The multiple classifiers share one feature extraction network, to reduce a complexity of the quality evaluation network.

In some aspects, in the identification result determination method, before the obtaining an identification result of the candidate user account according to the weighting factors of the N types and image matching degrees of the N types, the method further includes the following several steps. An executive agent for the following several steps is the computer device. Referring to FIG. 13, before operation 330, the method may further include:

Operation 327: Perform feature identification on the image of the i-th type, and determine a target feature of the i-th type, the target feature of the i-th type being configured for representing a distribution of the image of the i-th type of the to-be-identified target in a feature space. For example, feature identification is performed on the image of one of the plurality of types of images to determine a target feature of the image. The target feature of the image indicates a distribution of the image of the to-be-identified target in a feature space.

In some aspects, the computer device identifies the image through the above feature extraction network, to obtain a target feature representation of the to-be-identified target in the image. The target feature representation is configured for representing the to-be-identified target.

The target feature may be represented in a vector form or a matrix form. The target feature may be used as the “information configured for describing the image of the i-th type of the to-be-identified target” mentioned in the foregoing aspect.

Operation 328: Perform a matching operation on the target feature of the i-th type and a candidate feature of the i-th type, to obtain the image matching degree of the i-th type, the candidate feature of the i-th type being configured for representing a distribution of the image of the i-th type of the candidate user account in the feature space. For example, a matching operation between the target feature of the image and a candidate feature of the image is performed to obtain the image matching degree of the image. The candidate feature of the image indicates a distribution of the image of the candidate user account in the feature space.

In some aspects, the candidate feature of the i-th type is determined in advance. For any candidate user account, a user of the candidate user account may use a user terminal to provide, to the computer device in advance, the N types of images obtained by acquiring a user target by N kinds of acquisition modes. The computer device respectively performs feature identification on the N types of images uploaded using the candidate user account, and determines and stores user representations of the N types of the candidate user account. In some aspects, the candidate feature and the target feature are obtained in the same mode, namely, the candidate feature and the target feature are located in the same feature space.

For example, the computer device establishes an association with a database, and the user representations of the N types are stored in the database. The database may be deployed in a terminal device or a server. This aspect of this disclosure does not limit this.

In some aspects, the operation of performing the matching operation on the target feature of the i-th type and the candidate feature of the i-th type is implemented by calculating a similarity between the target feature of the i-th type and the candidate feature of the i-th type. For example, the image matching degree is the similarity between the target feature of the i-th type and the candidate feature of the i-th type. The computer device represents the similarity between the target feature of the i-th type and the candidate feature of the i-th type through a calculated similarity value, which determines the image matching degree of the i-th type for the candidate user account. A method for calculating the similarity includes, but is not limited to, at least one of the following: a cosine similarity, a Euclidean distance, and a Manhatton distance.

In some aspects, operation 330 of obtaining an identification result of the candidate user account according to the weighting factors of the N types and image matching degrees of the N types may be implemented as that the computer device performs weighted summation on the image matching degrees of the N types according to the weighting factors of the N types, to obtain the identification result of the candidate user account.

In some aspects, for a candidate user account, after the weighting factors of the N types of the candidate user account and the image matching degrees of the N types of the candidate user account are determined, for the i-th type of the N types, the computer device processes the image matching degree of the i-th type by using the weighting factor of the i-th type as a weight of the image matching degree of the i-th type, to obtain a weighted image matching degree of the i-th type. The computer device sums the weighted image matching degrees respectively corresponding to the N types, to obtain the identification result of the candidate user account.

For example, an example in which the N types include a first type and a second type, where an image of the first type is a color image and an image of the second type is an infrared image, is taken as an example. An identification result of a candidate user account may be expressed as follows:

$$cos ( θ ) = α * cos ( {θ}_{r} ) + ( 1 - a ) * cos ( {θ}_{i} )$$

where cos (0) represents the identification result of the candidate user account; α∈[0,1], a represents the weighting factor of the first type; cos(θᵣ) represents the image matching degree of the first type; (1−α) represents the weighting factor of the second type; and cos(θᵢ) represents the image matching degree of the second type.

The weighting factors of different types are determined by using the imaging qualities of the different types of images, and weighting processing is performed on the image matching degrees for the to-be-identified target and the candidate user account through the weighting factors. This enhances participation of images with good imaging qualities in the process of determining the identification result, provides more beneficial information for the process of determining the identification result, and helps improve the accuracy of the determined identification result.

In some aspects, after obtaining the quality scores of the N types of images, the computer device filters the N types of images according to the quality scores of the N types of images, and selects M types of images from the N types of images, M being a positive integer less than N and greater than 1. For example, the first M types of images having high quality scores are selected from the N types of images, to participate in the process of calculating the identification results of the plurality of candidate user accounts. This mode helps reduce a workload in the process of determining the identification results, and improves the identification result obtaining efficiency.

In an example, in a case that an image of a j-th type with a quality score greater than or equal to an upper limit value of score exists in the N types of images, the computer device obtains the identification results of the plurality of candidate user accounts according to the image of the j-th type of the to-be-identified target. In a case that the image of the j-th type does not exist in the N types of images, the identification results may be obtained by using the solution provided in this aspect of this disclosure. The upper limit value of score is a preset positive number.

For example, if the image of the i-th type includes only one image, and a color image and an infrared image are acquired. If a quality score of the color image is greater than the upper limit value of score, and a quality score of the infrared image is less than the upper limit value of score, the computer device filters out the infrared image, and directly determines the identification results of the plurality of candidate user accounts based on the color image. If the quality score of the color image and the quality score of the infrared image are both less than the upper limit value of score, the computer device performs operations 320 to 330 by using the solution provided by the foregoing aspect, to obtain the identification results.

In another example, if an image of a p-th type with a quality score greater than a lower limit value of score exists in the N types of images, the computer device obtains the identification results by using the solution provided in the foregoing aspect. In a case that the quality scores of the N types of images are all less than or equal to the lower limit value of score, the computer device determines that the N types of images that are obtained currently are invalid. In some aspects, the computer device reminds, through the image capture apparatus, the user that N types of images of the to-be-identified target need to be re-acquired. For example, a color image and an infrared image are acquired. If a quality score of the color image and a quality score of the infrared image are both less than the lower limit value of score, the computer device determines that the current image acquisition is invalid. If at least the quality score of the color image or the quality score of the infrared image is greater than the lower limit value of score, the computer device performs operations 320 to 330 by using the solution provided by the foregoing aspect, to obtain the identification results.

In another example, in a case that the quality scores of the N types of images are all less than an upper limit value of score and an image of a p-th type with a quality score greater than a lower limit value of score exists, the computer device performs operations 320 to 330 by using the solution provided by the foregoing aspect, to obtain the identification results. In a case that the quality scores of the N types of images are all less than or equal to the lower limit value of score, the computer device determines that the current image acquisition is invalid and needs to prompt the user to re-acquire images. In a case that an image of a j-th type with a quality score greater than or equal to the upper limit value of score exists in the N types of images, the computer device obtains the identification results based on the image of the j-th type.

For example, a color image, an infrared image, and a depth image are acquired. If a quality score corresponding to the color image and a quality score corresponding to the infrared image are both less than the upper limit value of score and greater than the lower limit value of score, and a quality score corresponding to the depth image is less than the lower limit value of score, weighting factors and identification results that respectively correspond to the color image, the infrared image, and the depth image may be calculated by using the solution provided in the foregoing aspect. If the quality score corresponding to the color image, the quality score corresponding to the infrared image, and the quality score corresponding to the depth image are all less than the lower limit value of score value, it is determined that the current image acquisition is invalid. If the quality score corresponding to the color image is greater than the upper limit value of score, and the quality score corresponding to the color image and the quality score corresponding to the depth image are less than the upper limit value off score, the identification results may be directly obtained according to the color image.

In some aspects, in a case that the quality scores of the N types of images are all less than an upper limit value of score, and an image of a p-th type with a quality score greater than a lower limit value of score and an image of a q-th type with a quality score greater than the lower limit value of score, if the quality scores of at least two types of images are less than the upper limit value of score and greater than the lower limit value of score, the image with the quality score less than the lower limit value of score may be filtered out, and the identification results are obtained through the above at least two types of images.

For example, if a quality score corresponding to a color image and a quality score corresponding to an infrared image are both less than the upper limit value of score and greater than the lower limit value of score, and a quality score corresponding to a depth image is less than the lower limit value of score, weighting factors and identification results that respectively correspond to the color image and the infrared image may be calculated by using the solution provided in the foregoing aspect.

The lower limit value of score is configured for indicating whether an imaging quality of an image is poor, and the upper limit value of score is configured for indicating whether an imaging quality of an image is good. The lower limit value of score and the upper limit value of score may be set and adjusted according to an empirical value. This aspect of this disclosure does not limit this.

For example, the identification results of the plurality of candidate user accounts may be sorted in an order of the identification results from large to small, to obtain an identification result sequence. A candidate user account corresponding to the 1-st identification result in the identification result sequence is determined to be the user account matched with the to-be-identified target.

In some aspects, referring to FIG. 14, the technical solution provided in this aspect of this disclosure is deployed on the palm swiping device 1401. A user swipes a palm on the palm swiping device 1401. The palm swiping device 1401 periodically acquires color images and infrared images for the palm, and selects an optimal color image and an optimal infrared image from the acquired images. Then, the palm swiping device 1401 determines, according to the optimal infrared image, that a living body is swiping the palm, respectively obtains a quality score of the color image and a quality score of the infrared image, and further respectively determines a weighting factor of the color image and a weighting factor of the infrared image. Then, the palm swiping device 1401 respectively obtains a similarity between the color image and each reserved feature representation in a database, and a similarity between the infrared image and each reserved feature representation in the database, then performs weighted summation on the similarity corresponding to the color image and the similarity corresponding to the infrared image according to the weighting factor of the color image and the weighting factor of the infrared image, to obtain an identification result between the palm and each reserved feature representation, and finally determines a user account matched with the palm according to the identification results. If it is determined that the user account matched with the to-be-identified target exists in the database, it may be determined that the palm swiping succeeds; otherwise, it is determined that the palm swiping fails.

The following will explain the training process of the quality evaluation model. In some aspects, the target detection network, the key point detection network, and the quality evaluation network in the quality evaluation model may be separately trained, or the quality evaluation model may be trained as a whole. This aspect of this disclosure does not limit this.

In some aspects, the training process of the target detection network may include following content.

A large quantity of sample images with labeled data are obtained, such as different types of images with palm labeled data. A predicted bounding box respectively corresponding to each sample image is obtained through the target detection network. Then, a training loss of the target detection network is obtained according to the predicted bounding box respectively corresponding to each sample image and the labeled data. Finally, iterative training is performed on the target detection network through the training loss of the target detection network, to obtain the target detection network that has been trained.

In some aspects, the training process of the key point detection network may include following content.

A large quantity of sample images with labeled data are obtained, such as different types of bounding box images with palm key point labeled data. A predicted key point respectively corresponding to each sample image is obtained through the key point detection network. Then, a training loss of the key point detection network is obtained according to the predicted key point respectively corresponding to each sample image and the labeled data. Finally, iterative training is performed on the key point detection network through the training loss of the key point detection network, to obtain the key point detection network that has been trained.

In some aspects, the training process of the quality evaluation network may include following content.
1. Obtain a plurality of sample image sets, each sample image set including a plurality of sample images corresponding to the same sample target.

For example, for a user, a plurality of different types of images of interest of a palm of the user are obtained, and for M users, M sample image sets may be obtained.
2. Obtain, for each sample image set in the plurality of sample image sets, feature representations of the sample images in the sample image set of the sample target.

In some aspects, feature extraction is performed on the sample images through an identification score evaluation model, to obtain the feature representations of the sample target in the sample images. The identification score evaluation model is configured to obtain an identification score. In some aspects, the identification score evaluation model may be constructed based on a FaceQnet or a self-researched feature algorithm.

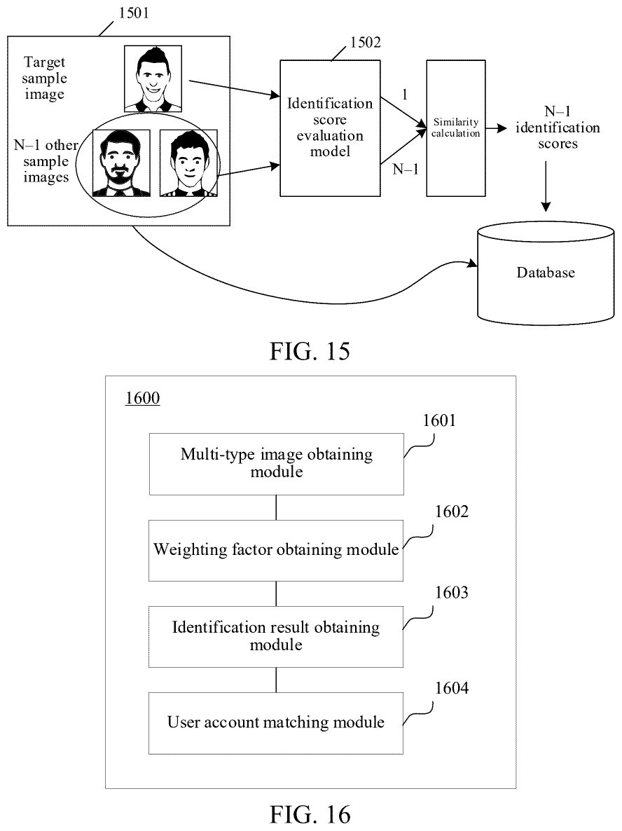

For example, referring to FIG. 15, a sample image set 1501 includes N sample images. Feature representations respectively corresponding to the N sample images may be obtained by performing feature extraction on the sample images through the identification score evaluation model 1502.
3. Obtain, from the sample images, a target sample image having a best imaging quality.

In some aspects, the target sample image may be manually annotated, or may be distinguished according to a feature algorithm. This aspect of this disclosure does not limit this.
4. Respectively calculate a similarity between a feature representation corresponding to another sample image in the sample image set and the feature representation corresponding to the target sample image, to use the similarity as an identification score corresponding to the another sample image.

The another sample image in the sample image set is a sample image in the sample image set other than the target sample image. In some aspects, a method for calculating the similarity may be a cosine similarity, a Euclidean distance, a Manhatton distance, or the like. The identification score may be configured for representing accuracy of identification performed by the identification score evaluation model on the sample target, and a similarity between the sample target in the another sample image and the sample target in the target sample image.

For example, referring to FIG. 15, after the feature representation corresponding to the target sample image in the sample image set 1501 and the feature representation corresponding to the another sample image in the sample image set 1501 are obtained through the identification score evaluation model 1502, and the similarity between the feature representation corresponding to the another sample image and the feature representation corresponding to the target sample image is respectively calculated by using the Euclidean distance, to obtain the identification score corresponding to the another sample image.

In a case that the identification score ranges from 0 to 1, the identification score corresponding to the target sample image is 1, and then the N sample images and the identification scores corresponding to the N sample images are correspondingly stored into the database.
5. Obtain, through the quality evaluation network, predicted quality scores respectively corresponding to the sample images in the plurality of sample image sets.

The predicted quality scores are quality scores corresponding to the sample images. The quality evaluation network in FIG. 12 is used to respectively perform the quality evaluation on the sample images, to obtain the predicted quality scores respectively corresponding to the sample images.
6. Train the quality evaluation network according to the predicted quality scores respectively corresponding to the sample images in the plurality of sample image sets and the identification scores respectively corresponding to the sample images in the plurality of sample image sets, to obtain the quality evaluation network that has been trained.

In some aspects, the identification scores respectively corresponding to the sample images are used as the labeled data respectively corresponding to the sample images, to perform supervised training on the quality evaluation network, so that the quality evaluation network that has been trained can be obtained.

For example, a training loss of the quality evaluation network is first determined according to the predicted quality scores respectively corresponding to the sample images in the plurality of sample image sets and the identification scores respectively corresponding to the sample images in the plurality of sample image sets. The training loss may be expressed as follows:

$$L ( Y / f ( x ) ) = {\sum }_{N} {( Y - f ( x ) )}^{2}$$

where Y is an identification score; f(x) is a predicted quality score corresponding to sample image x; and N is a total quantity of the sample images.

Iterative adjustment is performed on parameters of the quality evaluation network with the objective of minimizing the training loss of the quality evaluation network, to obtain the quality evaluation network that has been trained.

By obtaining the similarities between the feature representations of the sample target in different sample images and the feature representation of the sample target in the corresponding target sample image with a high imaging quality, a higher similarity indicates a higher imaging quality of the sample image, and a lower similarity indicates a lower imaging quality of the sample image. Namely, it indicates that the imaging quality of the sample image and the foregoing identification score are correlated. The quality evaluation network is trained by using a large quantity of sample images having identification scores, and finally, a quality score distribution of all the sample images and an identification score distribution of all the sample images on the quality evaluation network are similar. Namely, it can be considered that the quality evaluation network has a correct expression on the evaluation of the imaging quality.

The following describes apparatus aspects of this disclosure, which can be configured to perform the method aspects of this disclosure. For examples of details not disclosed in the apparatus aspects of this disclosure, reference can be made to the method aspects of this disclosure.

Referring to FIG. 16, it is a block diagram of an identification result determination apparatus according to an aspect of this disclosure. The apparatus has a function of implementing the foregoing method examples, and the function may be implemented by hardware or may be implemented by hardware executing corresponding software. The apparatus may be the foregoing computer device, or may be arranged in the computer device. As shown in FIG. 16, the apparatus 1600 includes: a multi-type image obtaining module 1601, a weighting factor obtaining module 1602, an identification result obtaining module 1603, and a user account matching module 1604.

The multi-type image obtaining module 1601 is configured to obtain N types of images obtained by acquiring a to-be-identified target, different types of images being obtained using different acquisition modes, and N being an integer greater than 1.

The weighting factor obtaining module 1602 is configured to determine, for an i-th type in the N types, a weighting factor of the i-th type according to an imaging quality of the image of the i-th type, i being a positive integer less than or equal to N.

The identification result obtaining module 1603 is configured to: for each candidate user account in the plurality of candidate user accounts, obtain an identification result of the candidate user account according to the weighting factors of the N types and the image matching degrees of the N types, the image matching degree of the i-th type being configured for representing a degree of feature matching between the to-be-identified target and the candidate user account with respect to the image of the i-th type.

The user account matching module 1604 is configured to determine, according to the identification results of the plurality of candidate user accounts, a user account matched with the to-be-identified target from the plurality of candidate user accounts.

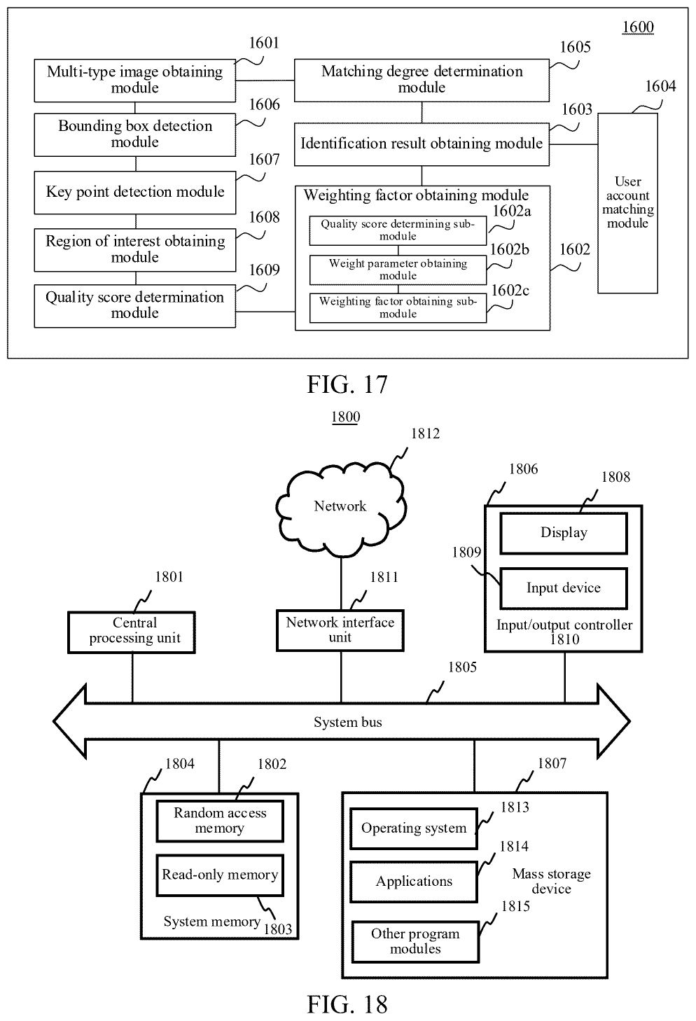

In some aspects, as shown in FIG. 17, the weighting factor obtaining module 1602 includes a quality score determination submodule 1602a, configured to: determine a quality score of the image of the i-th type, the quality score of the image of the i-th type being configured for representing the imaging quality of the image of the i-th type; a weight parameter obtaining submodule 1602b, configured to determine a weight representation parameter of the i-th type according to a value relationship between the quality score of the image of the i-th type and a quality score threshold, the weight representation parameter of the i-th type being configured for controlling a degree of impact of the image of the i-th type on the identification result; and a weighting factor obtaining submodule 1602c, configured to perform weighting factor calculation according to the weight representation parameter of the i-th type, to obtain the weighting factor of the i-th type.

In some aspects, the weight parameter obtaining submodule 1602b is configured to determine a smaller value from the quality score of the image of the i-th type and the quality score threshold to be the weight representation parameter of the i-th type; or determine a larger value from the quality score of the image of the i-th type and the quality score threshold to be the weight representation parameter of the i-th type; or determine a mean value of the quality score of the image of the i-th type and the quality score threshold to be the weight representation parameter of the i-th type.

In some aspects, the weighting factor obtaining submodule 1602c is configured to sum the weight representation parameters of the N types, to obtain a summation result; and calculate a ratio of the weight representation parameter of the i-th type to the summation result, to obtain the weighting factor of the i-th type.

In some aspects, the apparatus 1600 further includes a matching degree determination module 1605, configured to: perform feature identification on the image of the i-th type, and determine a target feature of the i-th type, the target feature of the i-th type being configured for representing a distribution of the image of the i-th type of the to-be-identified target in a feature space; and perform a matching operation on the target feature of the i-th type and a candidate feature of the i-th type, to obtain the image matching degree of the i-th type, the candidate feature of the i-th type being configured for representing a distribution of the image of the i-th type of the candidate user account in the feature space.

In some aspects, the identification result obtaining module 1603 is configured to perform weighted summation on the image matching degrees of the N types according to the weighting factors of the N types, to obtain the identification result of the candidate user account.

In some aspects, the imaging quality is determined through a quality evaluation model, and the quality evaluation model includes a target detection network, a key point detection network, and a quality evaluation network. The apparatus 1600 further includes: a bounding box detection module 1606, configured to perform target detection on the image of the i-th type through the target detection network, to determine a bounding box image of imaging of the to-be-identified target in the image of the i-th type, the bounding box image being an imaging region of the to-be-identified target in the image of the i-th type; a key point detection module 1607, configured to perform key point detection on the bounding box image through the key point detection network, to determine at least one key point of the to-be-identified target in the bounding box image; and a region of interest obtaining module 1608, configured to take a screenshot on the bounding box image according to the at least one key point, to obtain a region-of-interest image of the to-be-identified target, the region-of-interest image including an identification feature for identifying the to-be-identified target; and a quality score determination module 1609, configured to perform quality evaluation on the region-of-interest image through the quality evaluation network, to determine a quality score of the image of the i-th type, the quality score of the image of the i-th type being configured for representing the imaging quality of the image of the i-th type.

In some aspects, the region of interest obtaining module 1608 is configured to: determine a screenshot size and a screenshot position for the region-of-interest image according to the at least one key point of the to-be-identified target in the bounding box image; perform position adjustment on the screenshot position of the region-of-interest image, to obtain an adjusted screenshot position of the region-of-interest image, where an overlapping degree of the to-be-identified target in the region-of-interest image with the screenshot size and the adjusted screenshot position, and the to-be-identified target in the bounding box image satisfies a first condition; take a screenshot of an initial region-of-interest image on the bounding box image according to the screenshot size and the adjusted screenshot position; and scale the initial region-of-interest image to obtain the region-of-interest image.

In some aspects, the training process of the quality evaluation network may include following content: obtaining a plurality of sample image sets, each sample image set including a plurality of sample images corresponding to the same sample target; obtaining, for each sample image set in the plurality of sample image sets, feature representations of the sample images in the sample image set of the sample target; obtaining, from the sample images, a target sample image having a best imaging quality; respectively calculating a similarity between a feature representation corresponding to another sample image in the sample image set and the feature representation corresponding to the target sample image, to use the similarity as an identification score corresponding to the another sample image; obtaining, through the quality evaluation network, predicted quality scores respectively corresponding to the sample images in the plurality of sample image sets; and training the quality evaluation network according to the predicted quality scores respectively corresponding to the sample images in the plurality of sample image sets and the identification scores respectively corresponding to the sample images in the plurality of sample image sets, to obtain the quality evaluation network that has been trained.

In some aspects, the N types of images include color images and infrared images.

In conclusion, according to the technical solution provided in this aspect of this disclosure, after the plurality of different types of images corresponding to the to-be-identified target are obtained, the weighting factors of the types of images are determined according to the imaging quality respectively corresponding to the plurality of different types of images, and then the user account matched with the to-be-identified target is determined from the database based on the weighting factors of the types of images and with reference to the types of images, so that in the aspects of this disclosure, the weighting factors of the types of images are properly and accurately allocated, thereby improving the accuracy of the identification result and improving the target identification accuracy. Especially in a scenario with complex light, by allocating the weighting factors of the types of images properly and accurately, an image with good imaging quality has high impact on an identification result, and an image with poor imaging quality has low impact on an identification result, thereby improving the target identification accuracy.

In addition, when the apparatus provided in the foregoing aspect implements the functions of the apparatus, only division of the foregoing functional modules is used as an example for description. In an actual application, the functions may be allocated to and completed by different functional modules according to requirements. That is, an internal structure of the device is divided into different functional modules, to complete all or some of the functions described above. In addition, the apparatus provided in the foregoing aspects and the method aspects belong to the same concept. For details of an example implementation process, reference can be made to the method aspects. Details are not described herein again.

Referring to FIG. 18, it is a structural block diagram of a computer device provided according to an aspect of this disclosure. The computer device may be configured to implement the identification result determination method provided in the foregoing aspects, which may include the following content.

The computer device 1800 includes processing circuitry, for example, a central processing unit (CPU), a graphics processing unit (GPU), and a field programmable gate array (FPGA) 1801, a system memory 1804 (for example, a non-transitory computer-readable storage medium) including a random-access memory (RAM) 1802 and a read-only memory (ROM) 1803, and a system bus 1805 connecting the system memory 1804 to the CPU 1801. The computer device 1800 further includes a basic input/output (I/O) system 1806 helping transmit information between components in a server and a mass storage device 1807 configured to store an operating system 1813, an application program 1814, and another program module 1815.

The basic I/O system 1806 includes a display 1808 configured to display information and an input device 1809, such as a mouse or a keyboard, configured to input information for a user. The display 1808 and the input device 1809 are both connected to the CPU 1801 by using an input/output controller 1810 connected to the system bus 1805. The basic I/O system 1806 may further include the input and output controller 1810 to be configured to receive and process inputs from a plurality of other devices such as a keyboard, a mouse, and an electronic stylus. Similarly, the input/output controller 1810 further provides an output to a display screen, a printer, or another type of output device.

The mass storage device 1807 is connected to the CPU 1801 by using a mass storage controller (not shown) connected to the system bus 1805. The mass storage device 1807 and an associated computer-readable medium provide non-volatile storage for the computer device 1800. That is, the mass storage device 1807 may include a computer-readable medium (not shown) such as a hard disk or a compact disc ROM (CD-ROM) drive.

The computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory technology, a CD-ROM, a digital video disc (DVD) or another optical memory, a tape cartridge, a magnetic tape, a magnetic disk memory, or another magnetic storage device. Certainly, a person skilled in art can know that the computer storage medium is not limited to the foregoing several types. The system memory 1804 and the mass storage device 1807 may be collectively referred to as a memory.

According to the aspects of this disclosure, the computer device 1800 may further be connected, through a network such as the Internet, to a remote computer on the network and run. For example, the computer device 1800 may be connected to a network 1812 by using a network interface unit 1811 connected to the system bus 1805, or may be connected to another type of network or a remote computer system (not shown) by using a network interface unit 1811.

The memory further includes a computer program. The computer program is stored in the memory and is configured to be run by one or more processors to implement the above identification result determination method.

In some aspects, a computer-readable storage medium, such as a non-transitory computer-readable storage medium is further provided, having a computer program stored therein. The computer program, when run by a processor, implements the foregoing identification result determination method.

In some aspects, the computer-readable storage medium may include: a read-only memory (ROM), a random-access memory (RAM), a solid state drive (SSD), an optical disc, or the like. The RAM may include a resistance RAM (ReRAM) and a dynamic RAM (DRAM).

In some aspect, a computer program product is further provided, including a computer program. The computer program is stored in a computer-readable storage medium. A processor of a computer device reads the computer program from the computer-readable storage medium and runs the computer program, to cause the computer device to perform the foregoing identification result determination method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In addition, according to the aspects of this disclosure, a prompt interface or a pop-up window may be displayed, or voice prompt information may be outputted before and during collecting user-related data of a user. The prompt interface, the pop-up window, or the voice prompt information is configured for prompting the user that data related to the user is currently being collected, so that this disclosure only starts to perform related operations of obtaining the user-related data after obtaining a confirmation operation of the user for the prompt interface or the pop-up window, otherwise (namely, when the confirmation operation of the user for the prompt interface or the pop-up window is not obtained), ends the related operations of obtaining the user-related data, namely, skips obtaining the user-related data.

“Plurality of” mentioned in the specification means two or more. “And/or” describes an association relationship for describing associated objects and represents that three relationships may exist. For example, A and/or B may represent: only A exists, both A and B exist, and only B exists. The character “/” in this specification indicates an “or” relationship between the associated objects. In addition, the step numbers described in this specification show a possible execution sequence of the steps. In some other aspects, the steps may not be performed according to the number sequence. For example, two steps with different numbers may be performed simultaneously, or two steps with different numbers may be performed according to a sequence contrary to the sequence shown in the figure. This is not limited in the aspects of this disclosure.

What is claimed is:

1. A method for determining a user account, the method comprising:
obtaining a plurality of images of a to-be-identified target, the plurality of images including a plurality of types of images, each type of the plurality of types of images being obtained using a different acquisition mode;
determining, for each type of image in the plurality of types of images, a weighting factor of the respective type of image based on an image quality of the respective type of image;
for each candidate user account of a plurality of candidate user accounts, obtaining an identification result associated with the respective candidate user account based on the weighting factors of the plurality of types of images and image matching degrees of the plurality of types of images, the image matching degree of each of the plurality of types of images indicating a degree of feature matching between the to-be-identified target and the respective candidate user account based on the respective type of image; and
determining, based on the identification results of the plurality of candidate user accounts, the user account that matches the to-be-identified target from the plurality of candidate user accounts.

2. The method according to claim 1, wherein the determining the weighting factor of the respective type of image comprises:
determining a quality score of the respective type of image, the quality score of the respective type of image indicating the image quality of the respective type of image;
determining a weight representation parameter of the respective type of image based on a value relationship between the quality score of the respective type of image and a quality score threshold, the weight representation parameter indicating a degree of impact of the respective type of image on the identification result; and
performing weighting factor calculation based on the weight representation parameter to obtain the weighting factor of the respective type of image.

3. The method according to claim 2, wherein the determining the weight representation parameter of the respective type of image comprises:
determining the weight representation parameter based on a value of at least one of the quality score of the respective type of image and the quality score threshold.

4. The method according to claim 2, wherein the performing the weighting factor calculation comprises:
summing the weight representation parameters of the plurality of types of images, to obtain a summation result; and
calculating a ratio of the weight representation parameter of the respective type of image to the summation result to obtain the weighting factor of the respective type of image.

5. The method according to claim 1, further comprising:
performing feature identification on the image of one of the plurality of types of images to determine a target feature of the image, the target feature of the image indicating a distribution of the image of the to-be-identified target in a feature space; and
performing a matching operation between the target feature of the image and a candidate feature of the image, to obtain the image matching degree of the image, the candidate feature of the image indicating a distribution of the image of the candidate user account in the feature space.

6. The method according to claim 1, wherein the obtaining the identification result comprises:
performing weighted summation on the image matching degrees of the plurality of types of images of a candidate user account of the plurality of candidate user accounts based on the weighting factors of the plurality of types of images to obtain the identification result of the candidate user account.

7. The method according to claim 1, wherein the image quality is determined via a quality evaluation model that includes a target detection network, a key point detection network, and a quality evaluation network, and the method further comprises:
performing target detection on the image of one of the plurality of types of images via the target detection network to determine a bounding box image of the to-be-identified target in the image, the bounding box image indicating an imaging region of the to-be-identified target in the image;
performing key point detection on the bounding box image via the key point detection network to determine at least one key point of the to-be-identified target in the bounding box image;
obtaining a region-of-interest image of the to-be-identified target based on the at least one key point, the region-of-interest image including an identification feature or identifying the to-be-identified target; and
performing quality evaluation on the region-of-interest image via the quality evaluation network to determine a quality score of the image, the quality score of the image indicating the image quality of the image.

8. The method according to claim 7, wherein the obtaining the region-of-interest image comprises:
determining a screenshot size and a screenshot position for the region-of-interest image based on the at least one key point;
performing position adjustment on the screenshot position to obtain an adjusted screenshot position of the region-of-interest image, an overlapping degree between (i) the to-be-identified target in the region-of-interest image with the screenshot size and the adjusted screenshot position, and (ii) the to-be-identified target in the bounding box image satisfies a first condition;
taking a screenshot of an initial region-of-interest image on the bounding box image based on the screenshot size and the adjusted screenshot position; and
scaling the initial region-of-interest image to obtain the region-of-interest image.

9. The method according to claim 7, further comprising:
training the quality evaluation network prior to performing the quality evaluation, wherein the training the quality evaluation network comprises:
obtaining a plurality of sample image sets, each sample image set including a plurality of sample images corresponding to a same sample target;
obtaining, for each sample image set in the plurality of sample image sets, feature representations of the sample images in the respective sample image set of the sample target;
obtaining, from the sample images, a target sample image having a highest image quality;
calculating, for each sample image other than the target sample image in each sample image set, a similarity between a feature representation of the respective sample image and a feature representation of the target sample image to use as an identification score for the respective sample image;
obtaining, via the quality evaluation network, predicted quality scores for the sample images in the plurality of sample image sets; and
training the quality evaluation network based on the predicted quality scores and the identification scores to obtain a trained quality evaluation network.

10. The method according to claim 1, wherein the plurality of types of images includes color images and infrared images.

11. An apparatus, comprising:
processing circuitry configured to:
obtain a plurality of images of a to-be-identified target, the plurality of images including a plurality of types of images, each type of the plurality of types of images being obtained using a different acquisition mode;
determine, for each type of image in the plurality of types of images, a weighting factor of the respective type of image based on an image quality of the respective type of image;
for each candidate user account of a plurality of candidate user accounts, obtain an identification result associated with the respective candidate user account based on the weighting factors of the plurality of types of images and image matching degrees of the plurality of types of images, the image matching degree of each of the plurality of types of images indicating a degree of feature matching between the to-be-identified target and the respective candidate user account based on the respective type of image; and
determine, based on the identification results of the plurality of candidate user accounts, the user account that matches the to-be-identified target from the plurality of candidate user accounts.

12. The apparatus according to claim 11, wherein the processing circuitry is configured to:
determine a quality score of the respective type of image, the quality score of the respective type of image indicating the image quality of the respective type of image;
determine a weight representation parameter of the respective type of image based on a value relationship between the quality score of the respective type of image and a quality score threshold, the weight representation parameter indicating a degree of impact of the respective type of image on the identification result; and
perform weighting factor calculation based on the weight representation parameter to obtain the weighting factor of the respective type of image.

13. The apparatus according to claim 12, wherein the processing circuitry is configured to:
determine the weight representation parameter based on a value of at least one of the quality score of the respective type of image and the quality score threshold.

14. The apparatus according to claim 12, wherein the processing circuitry is configured to:
sum the weight representation parameters of the plurality of types of images, to obtain a summation result; and
calculate a ratio of the weight representation parameter of the respective type of image to the summation result to obtain the weighting factor of the respective type of image.

15. The apparatus according to claim 11, wherein the processing circuitry is configured to:
perform feature identification on the image of one of the plurality of types of images to determine a target feature of the image, the target feature of the image indicating a distribution of the image of the to-be-identified target in a feature space; and
perform a matching operation between the target feature of the image and a candidate feature of the image, to obtain the image matching degree of the image, the candidate feature of the image indicating a distribution of the image of the candidate user account in the feature space.

16. The apparatus according to claim 11, wherein the processing circuitry is configured to:
perform weighted summation on the image matching degrees of the plurality of types of images of a candidate user account of the plurality of candidate user accounts based on the weighting factors of the plurality of types of images to obtain the identification result of the candidate user account.

17. The apparatus according to claim 11, wherein the image quality is determined via a quality evaluation model that includes a target detection network, a key point detection network, and a quality evaluation network, and the processing circuitry is configured to:
perform target detection on the image of one of the plurality of types of images via the target detection network to determine a bounding box image of the to-be-identified target in the image, the bounding box image indicating an imaging region of the to-be-identified target in the image;
perform key point detection on the bounding box image via the key point detection network to determine at least one key point of the to-be-identified target in the bounding box image;
obtain a region-of-interest image of the to-be-identified target based on the at least one key point, the region-of-interest image including an identification feature or identifying the to-be-identified target; and
perform quality evaluation on the region-of-interest image via the quality evaluation network to determine a quality score of the image, the quality score of the image indicating the image quality of the image.

18. The apparatus according to claim 17, wherein the processing circuitry is configured to:
determine a screenshot size and a screenshot position for the region-of-interest image based on the at least one key point;
perform position adjustment on the screenshot position to obtain an adjusted screenshot position of the region-of-interest image, an overlapping degree between (i) the to-be-identified target in the region-of-interest image with the screenshot size and the adjusted screenshot position, and (ii) the to-be-identified target in the bounding box image satisfying a first condition;
take a screenshot of an initial region-of-interest image on the bounding box image based on the screenshot size and the adjusted screenshot position; and
scale the initial region-of-interest image to obtain the region-of-interest image.

19. The apparatus according to claim 17, wherein the processing circuitry is configured to:
obtain a plurality of sample image sets, each sample image set including a plurality of sample images corresponding to a same sample target;
obtain, for each sample image set in the plurality of sample image sets, feature representations of the sample images in the respective sample image set of the sample target;
obtain, from the sample images, a target sample image having a highest image quality;
calculate, for each sample image other than the target sample image in each sample image set, a similarity between a feature representation of the respective sample image and a feature representation of the target sample image to use as an identification score for the respective sample image;
obtain, via the quality evaluation network, predicted quality scores for the sample images in the plurality of sample image sets; and
train the quality evaluation network based on the predicted quality scores and the identification scores to obtain a trained quality evaluation network.

20. A non-transitory computer-readable storage medium storing instructions which, when executed by a processor, cause the processor to perform:
obtaining a plurality of images of a to-be-identified target, the plurality of images including a plurality of types of images, each type of the plurality of types of images being obtained using a different acquisition mode;
determining, for each type of image in the plurality of types of images, a weighting factor of the respective type of image based on an image quality of the respective type of image;
for each candidate user account of a plurality of candidate user accounts, obtaining an identification result associated with the respective candidate user account based on the weighting factors of the plurality of types of images and image matching degrees of the plurality of types of images, the image matching degree of each of the plurality of types of images indicating a degree of feature matching between the to-be-identified target and the respective candidate user account based on the respective type of image; and
determining, based on the identification results of the plurality of candidate user accounts, the user account that matches the to-be-identified target from the plurality of candidate user accounts.
